(19) United States
(12) Patent Application Publication
(10) Pub. No.: US 2004/0198582 A1
(43) Pub. Date: Oct. 7, 2004

(54) Optical elements and methods of making optical elements

(76) Inventors: Nicholas F. Borrelli, Elmira, NY (US); George B. Hares, Corning, NY (US); Joseph F. Schroeder, Lindley, NY (US)

Correspondence Address: CORNING INCORPORATED, SP-TI-3-1, CORNING, NY, 14831

(21) Appl. No.: 10/405,680

(22) Filed: Apr. 1, 2003

(51) Int. Cl. C03C 3/108

(52) U.S. Cl. 501/56; 501/61; 65/386; 65/392; 65/390

(57) ABSTRACT

The present invention provides an optical element including a silver halide-containing glass material having a concentration of less than 0.001 wt % cerium; and a refractive index pattern formed in the silver halide-containing glass material, the refractive index pattern including regions of high refractive index and regions of low refractive index, the difference between the refractive indices of the high refractive index regions and the low refractive index regions being at least 4×10⁻⁵ at a wavelength of 633 nm. The present invention also provides methods for making optical elements from siliver halide-containing glass materials.

### BACKGROUND OF THE INVENTION

1. Field of the Invention

The present invention relates generally to optical elements and methods for their manufacture, and more specifically to glass-based optical elements having a refractive index pattern formed therein, and methods for their manufacture.

2. Technical Background

Diffractive optical elements find use in a wide variety of fields. For example, diffractive optical elements are useful for filtering, beam shaping and light collection in display, security, defense, metrology, imaging and communications applications.

One especially useful diffractive optical element is a Bragg grating. A Bragg grating is formed by a periodic modulation of refractive index in a transparent material. Bragg gratings reflect wavelengths of light that satisfy the Bragg phase matching condition, and transmit all other wavelengths. Bragg gratings are especially useful in telecommunications applications; for example, they have been used as selectively reflecting filters in multiplexing/demultiplexing applications; and as wavelength-dependent pulse delay devices in dispersion compensating applications.

Bragg gratings are generally fabricated by exposing a photosensitive material to a pattern of radiation having a periodic intensity. Many photosensitive materials have been used; however, few have provided the desired combination of performance and cost. For example, Bragg gratings have been recorded in germanium-doped silica glass optical fibers; while such gratings are relatively robust, the fiber geometry and high melting point of the material make these gratings inappropriate for many optical systems. Bragg gratings have also been recorded in photorefractive crystals such as iron-doped lithium niobate. These filters had narrow-band filtering performance, but suffered from low thermal stability, opacity in the UV region, and sensitivity to visible radiation after recording. Photosensitive polymers have also been used as substrates for Bragg gratings; however, devices formed from polymeric materials tend to have high optical losses and high temperature sensitivity.

Photosensitive glasses based on the Ce³⁺/Ag⁺ redox couple have been proposed as substrates for the formation of diffractive optical elements. In these materials, exposure to radiation (λ˜366 nm) causes a photoreduction of Ag⁺ to colloidal Ag⁰, which acts as a nucleus for crystallization of a NaF phase in a subsequent heat treatment step. These glasses had very high absorbances at wavelengths less than 300 nm, making them unsuitable for use with commonly used 248 nm excimer laser exposure systems.

### SUMMARY OF THE INVENTION

One embodiment of the present invention relates to an optical element including a silver halide-containing glass material having a concentration of less than 0.001 wt % cerium; and a refractive index pattern formed in the silver halide-containing glass material, the refractive index pattern including regions of high refractive index and regions of low refractive index, the difference between the refractive indices of the high refractive index regions and the low refractive index regions being at least 4×10⁻⁵ at a wavelength of 633 nm.

Another embodiment of the present invention relates to a method of making an optical element, the method including the steps of providing a silver halide-containing glass material; exposing the glass material to patterned ultraviolet radiation having a peak wavelength of less than about 300 nm, thereby forming exposed regions and unexposed regions; and subjecting the exposed glass material to a heat treatment to form the optical element, wherein exposed regions of the glass material have a substantially different refractive index than unexposed regions of the glass material after being subjected to the heat treatment.

Another embodiment of the present invention relates to a method of making an optical element, the method including the steps of providing a silver halide-containing glass material; exposing the glass material to pulsed patterned radiation having a peak wavelength of between 600 nm and 1000 nm, thereby forming exposed regions and unexposed regions; and subjecting the exposed glass material to a heat treatment to form the optical element, wherein exposed regions of the glass material have a substantially different refractive index than unexposed regions of the glass material after being subjected to the heat treatment.

The devices and methods of the present invention result in a number of advantages over prior art devices and methods. For example, the present invention provides a method suitable for the fabrication of bulk (i.e. not guided wave) Bragg grating devices. The method uses a photosensitive glass material that may be fabricated using conventional glass melting techniques, providing for simplified manufacture of a variety of shapes. The method may be performed using a conventional 248 nm laser exposure system. The optical elements of the present invention have high photoinduced refractive index changes that are stable at elevated temperatures.

Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings are not necessarily to scale, and sizes of various elements may be distorted for clarity. The drawings illustrate one or more embodiment(s) of the invention, and together with the description serve to explain the principles and operation of the invention.

### BRIEF DESCRIPTION OF THE DRAWINGS

FIG. 1 is a schematic view of a method according to one embodiment of the present invention;

FIG. 2 is an absorbance spectrum for both exposed and unexposed regions of the glass sample of Example 1 after heat treatment; and

FIG. 3 is a schematic diagram of the apparatus used in Example 3.

### DETAILED DESCRIPTION OF THE PREFERRED EMBODIMENTS

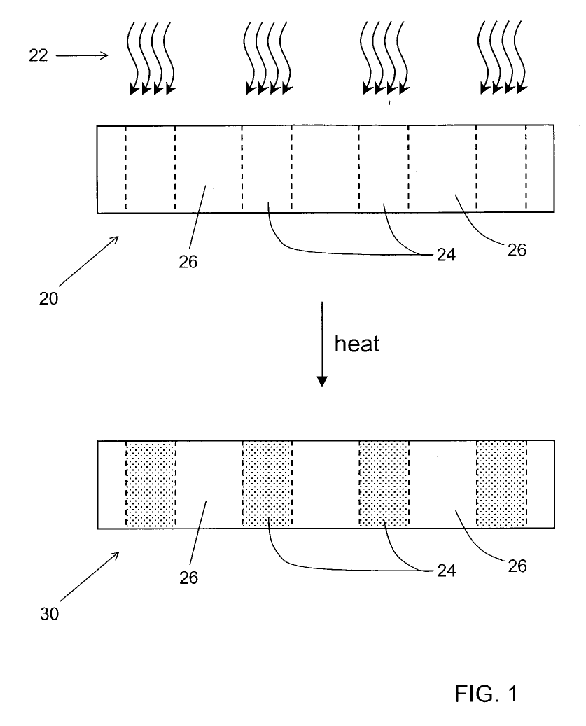

One embodiment of the present invention relates to a method of making an optical element. The method of this embodiment of the invention is shown in schematic view in FIG. 1. A silver halide-containing glass material 20 is provided. The glass material 20 is exposed to patterned ultraviolet radiation 22, forming exposed regions 24 and unexposed regions 26. Patterned ultraviolet radiation 22 has a peak wavelength of less than about 300 nm. The exposed glass material is then subjected to a heat treatment step (e.g. in furnace 28), thereby forming an optical element 30. In optical element 30, the exposed regions 24 have a substantially different refractive index than unexposed regions 26 after being subjected to the heat treatment.

In the methods according to this embodiment of the invention, the glass material contains silver. Desirably, the glass material includes between about 0.1 wt % and about 1 wt % silver. In certain especially desirable embodiments of the present invention, the glass material includes between about 0.3 wt % and about 0.6 wt % silver. The degree of photosensitivity of the glass material depends strongly on the silver content; however, for a given set of heat treatment conditions, too much silver can cause the unexposed regions to undergo an undesired index change during the heat treatment. The skilled artisan will choose an appropriate silver concentration, depending on the particular glass composition and the heat treatment conditions to be used.

The glass materials used in this embodiment of the invention are essentially cerium free. In desirable embodiments of the invention, the glass includes less than about 0.001 wt % cerium. Cerium is undesirable for use in photosensitive glasses to be written at 248 nm, due to the unavoidable presence of highly absorbing Ce⁴⁺ species. The present inventors have determined that cerium is not necessary to achieve a desirably high photosensitivity in a silver-containing glass material.

The glass material desirably includes a weak reducing agent. While not wishing to be held to a particular explanation, the inventors surmise that the photoreduction of silver in the exposure step forms a hole (i.e. a missing electron in the glass structure), and that the weak reducing agent acts to trap the hole by being oxidized. Suitable weak reducing agents include antimony(III), arsenic(III), iron(II) and tin(II) species. Antimony(III) species such as Sb₂O₃ are especially preferred, as they can not only act as a hole trap during the exposure step, they can also prevent premature reduction of the silver during the melting of the glass. In especially desirable embodiments of the invention, Sb₂O₃ is present in a concentration of about 0.5 wt % to about 6 wt %.

The glass materials used in the present invention may be of a wide variety of classes. For example, the glass materials of the present invention may be borosilicate glasses. An example of a suitable family of glass material compositions is given below in Table 1. Amounts are given in weight percent on an as-batched basis, as is customary in the art. The glass materials used in the present invention may also include alkaline earth elements other than barium (e.g. calcium, magnesium).

TABLE 1

| Species | Suitable ranges |
|---|---|
| SiO₂ | about 35% to about 75% |
| B₂O₃ | about 5% to about 21% |
| PbO + ZnO + | about 5% to about 50% |
| BaO | |
| PbO | up to about 50% |
| ZnO | up to about 15% |
| BaO | up to about 5% |
| Sb₂O₃ + SnO + | about 1% to about 4% |
| FeO + As₂O₃ | |
| Na₂O | up to about 12% |
| Ag | about 0.1 wt % to about 1 wt % |
| Cl | about 0.1 wt % to about 1 wt % |

An especially desirable family of glass material compositions includes about 60 to about 72% SiO₂; about 12 to about 19% B₂O₃; about 6 to about 12% Na₂O; about 3 to about 7% ZnO; about 0.5 to about 3% F; about 1% to about 4% Sb₂O₃; about 0.2 to about 0.6 wt % Ag; and about 0.15 to about 0.4 wt % Cl.

The methods of the present invention include an exposure step and a heat treatment step. While not wishing to be held to a particular theory, the inventors surmise that the combination of the exposure and heat treatment causes silver to be reduced onto AgCl crystallites in the glass in the exposed regions. The presence of the reduced silver causes the exposed regions of the glass material to have a higher index of refraction than the unexposed regions of the glass material after the heat treatment step.

According to one embodiment of the present invention, the exposure step is carried out with patterned ultraviolet radiation having a peak wavelength of less than about 300 nm. Desirably, the patterned ultraviolet radiation has a peak wavelength of less than about 260 nm. Excimer laser sources operating at 248 nm are especially useful in the methods of the present invention. For example, exposure doses of from about 5 W/cm² to 5040 W/cm² at 248 nm can be achieved with a 0.5-28 minute exposure to a pulsed excimer laser operating at 30-50 mJ/cm²/pulse and 5-60 Hz (i.e. pulses/sec). The pattern of the radiation may be formed using methods familiar to the skilled artisan. For example, a phase mask or an absorption mask may be used. Alternatively, a focused beam of radiation may be scanned or rastered along the glass material to form the pattern. Interference techniques (e.g. holography) may also be used. In some embodiments of the invention, even the least exposed regions of the glass material may be subjected to a minor amount of radiation. Further, for certain applications it may be desirable to use patterned radiation having a continuously varying intensity. As such, the term “unexposed region” in the present application is used to designate the regions of the glass material exposed to the least amount of radiation, while the term “exposed region” is used to designate the regions of glass material exposed to the most radiation.

According to another embodiment of the present invention, the exposure step is carried out using a pulsed laser source operating to produce radiation in the wavelength range of 600 nm to 1000 nm. The pulsed laser sources according to this embodiment of the invention desirably provide pulses having a pulsewidth of less than about 150 fs. The wavelength of the pulsed laser source is desirably chosen to one that the glass material does not linearly absorb. The pulses are focused using a focusing lens (e.g. a microscope objective); near the focal point, the pulse is sufficiently intense to cause the material to nonlinearly absorb the pulses, presumably exciting a transition in the neighborhood of 250 nm in wavelength. Hence, with a judicious choice of pulse energy, exposure time, and focal parameters, an index change can be caused at any depth in a bulk glass sample. Alternatively, the pulsed radiation can have a larger pulse power and be substantially unfocused, so that it may be used to write through thick samples (e.g. 100 mm) of glass. Femtosecond laser writing is described in more detail in, for example, U.S. patent application Ser. No. 09/954,500, entitled “Direct Writing of Optical Devices in Silica-Based Glass Using Femtosecond Pulse Lasers,” which is hereby incorporated herein by reference in its entirety.

After exposure, the glass material is subjected to a heat treatment. During the heat treatment, the exposed regions of the glass develop substantial absorption, presumably due to the formation of Ag⁰ particles. Desirably, the unexposed regions of the glass develop substantially less absorption than the exposed regions during the heat treatment step. The skilled artisan will determine the heat treatment conditions appropriate for a particular glass material. For example, the heat treatment may be performed at a temperature between about 450° C. and about 750° C. for a time between about 30 seconds and 3 hours. When using the particular borosilicate glass materials described above, the heat treatment is desirably performed at a temperature of about 500 to about 600° C. During the heat treatment, it may be desirable to cover the surface of the glass, for example, with a block of high purity fused silica, in order to protect the surface from discoloration in the furnace. Any discoloration formed may be polished away using methods familiar to the skilled artisan.

The optical elements formed by the methods of the present invention have a regions of high refractive index (i.e. the exposed regions), and regions of low refractive index (i.e. the unexposed regions). Desirably, the maximum index difference between the exposed regions of the optical element and the unexposed regions of the optical element is at least about 4×10⁻⁵ at a wavelength of 633 nm. More desirably, the maximum index difference between the exposed regions of the optical element and the unexposed regions of the optical element is at least about 1×10⁻⁴ at a wavelength of 633 nm. Especially desirable optical elements have a maximum index difference between the exposed regions of the optical element and the unexposed regions of at least about 2×10⁻⁴ at a wavelength of 633 nm. The skilled artisan will adjust the glass composition and exposure conditions in accordance with the present invention in order to maximize the index contrast in the optical element.

Another embodiment of the present invention relates to an optical element including a silver halide-containing glass material having a refractive index pattern formed therein. The refractive index pattern includes regions of high refractive index and regions of low refractive index; the maximum difference between the refractive indices of the high refractive index regions and the low refractive index regions is at least 4×10⁻⁵ at a wavelength of 633 nm. Desirably, the maximum refractive index is at least about 1×10⁻⁴ at 633 nm. In especially desirable embodiments of the invention, the refractive index difference is at least about 2×10⁻⁴. The optical elements according to this embodiment of the invention may be made using the glass materials and methods described hereinabove.

The optical elements made using the methods of the present invention may take a wide variety of shapes. For example, the optical elements may be formed as planar waveguides or optical fibers. In alternative desirable embodiments of the invention, the optical elements may be formed as bulk glass bodies having a smallest dimension longer than about 70 μm. In especially desirable embodiments of the present invention, the optical elements are bulk glass bodies having a smallest dimension longer than about 300 μm. Since the optical elements of the present invention are desirably made in glass materials having relatively low absorbance at 248 nm, the refractive index patterns formed therein may be quite thick. For example, the refractive index pattern may have a smallest dimension of at least 0.1 mm. In certain embodiments of the invention, the refractive index pattern has a smallest dimension of at least 0.5 mm. In especially desirable embodiments of the invention, the refractive index pattern has a smallest dimension of about 1 mm. In order to provide an increased thickness of the refractive index pattern, the skilled artisan may wish to perform the exposure at a somewhat higher wavelength (e.g. 266 nm).

In order to provide for ease of manufacture into a variety of shapes using standard glass melting techniques, it is desirable for the glass material used in the present invention to have a melting point of less than about 1650° C. In especially desirable embodiments of the present invention, the glass material has a melting point of less than about 1400° C.

The optical elements of the present invention have advantageously high temperature stability. For example, desirable optical elements of the present invention are stable to a temperature of 350° C. Desirably, the optical elements of the present are stable up to the strain point of the glass material. The glass materials described herein have strain points in the range of about 350° C. to about 550° C. As used herein, an optical element is stable if it exhibits a decrease in diffraction efficiency of less than about 10% upon exposure to a given set of conditions.

### EXAMPLES

The present invention is further described by the following non-limiting examples.

### Example 1

The photosensitive glass materials of Table 2 were melted using methods familiar to the skilled artisan. Iota sand, boric acid, sodium chloride, sodium nitrate, sodium silicofluoride, antimony trioxide, zinc oxide and alumina were used as batch materials. The batched mixture was ball milled for 60 minutes, melted at 1425° C. for four hours, cast into slabs 4 inches wide and 1 inch thick, and annealed at 650° C. Concentrations are given in wt % on an as-batched basis.

TABLE 2

| | A [265 EA] | B | C | D [265 IC] |
|---|---|---|---|---|
| SiO₂ | 67.1 | 67.1 | 67.1 | 67.1 |
| B₂O₃ | 15.1 | 15.7 | 15.7 | 16.1 |
| Na₂O | 8.9 | 8.3 | 8.3 | 7.3 |
| Al₂O₃ | 0 | 0 | 0 | 3.0 |
| ZnO | 5.0 | 5.0 | 5.0 | 5.0 |
| F | 1.7 | 1.7 | 1.7 | 1.7 |
| Sb₂O₃ | 2.0 | 2.0 | 2.0 | 1.0 |
| Ag | 0.66 | 0.44 | 0.22 | 0.33 |
| Cl | 0.22 | 0.22 | 0.22 | 0.22 |

### Example 2

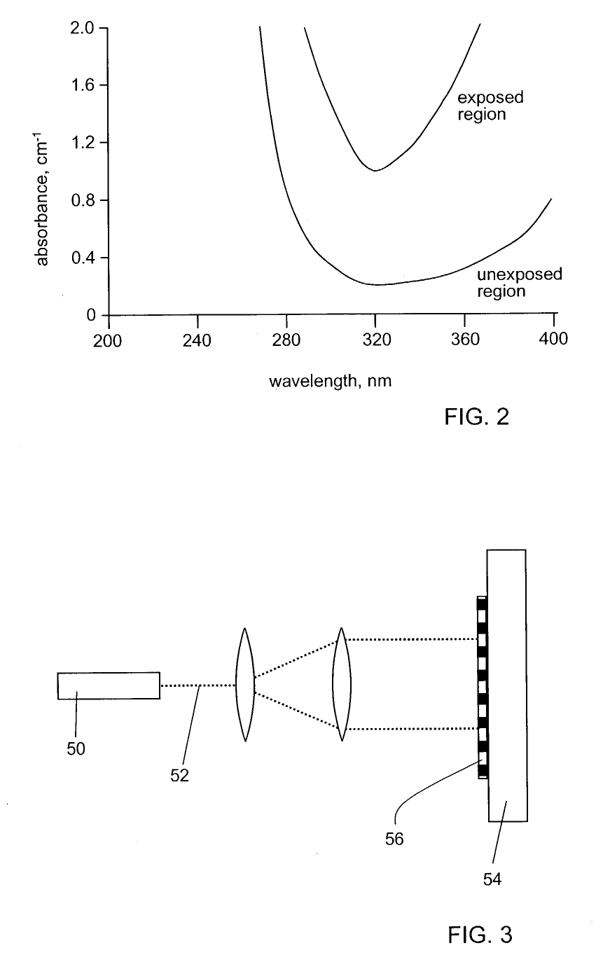

Glass material A of Example 1 was formed into a 1 mm thick slide. Part of the slide was exposed to 248 nm radiation from a KrF excimer laser for 6 minutes. The fluence per pulse was about 31 mJ/cm², and the laser operated at a pulse rate of 50 Hz. The slide was then heat treated in a furnace at 540° C. for 5 minutes, and allowed to cool to room temperature. FIG. 2 shows absorption spectra of the exposed region and the unexposed region. The skilled artisan will note that the exposed region of the sample developed significantly more absorption than did the unexposed region.

### Example 3

Glass material A of Example 1 was formed into slides 1 mm in thickness. The slides were exposed as shown in FIG. 3. The output of a KrF excimer laser 50 operating at 248 nm and 50 Hz was expanded such that its fluence was 40 mJ/cm²/pulse. A slide 54 of glass material A was exposed from its largest face 56 through a chrome absorption mask 52 having a 10 μm grating pitch. After exposure for a desired time, the slide was thrust into a furnace at a desired temperature, and allowed to remain there for a desired time. The slide was removed from the furnace and allowed to cool to room temperature. The grating was about 15 mm long.

The Bragg gratings so formed in the glass slides were illuminated from the edge of the slide with collimated 633 nm radiation. The diffraction efficiency was used to determine the index contrast between the exposed regions and unexposed regions of the Bragg gratings using the equation

$$efficiency = {sin}^{2} ( \frac{2 πΔ nL}{λ} )$$

where λ is the wavelength of the illuminating light, L is the thickness of the grating, and Δn is the index contrast between the exposed and unexposed regions of the grating. Refractive index contrast data for various exposure times and heat treatment conditions are given in Table 3. Good results have also been obtained using much lower total exposures (e.g. 10 Hz pulse rate, 1 minute total time, 40 mJ/cm²/pulse).

TABLE 3

| Exposure | Heat treatment | Heat treatment | n_{exposed} − n_{unexposed} (at |
|---|---|---|---|
| time (min) | temperature (° C.) | time (min) | 633 nm, ×10⁻⁴) |
| 28 | 500 | 10 | 0.16 |
| 12 | 520 | 7 | 1.10 |
| 6 | 540 | 5 | 1.38 |
| 17 | 560 | 3 | 1.96 |
| 28 | 560 | 3 | 1.54 |
| 22 | 560 | 3 | 2.8 |
| 12 | 580 | 2 | 1.54 |
| 6 | 600 | 2 | 1.20 |

### Example 4

Glass materials A, B, and C were prepared as slides as described above in Example 3. These glasses were compositionally very similar, but had differing amounts of silver. A portion of each slide was exposed to 248 nm radiation (70 mJ/cm²/pulse, 50 Hz) or 56 minutes. The slides were heat treated at 550° C. for 1.5 hours. Glass material C, with 0.22 wt % silver, exhibited very little index change in the exposed region. Both glass materials A and B (0.66 and 0.44 wt % silver, respectively) exhibited about a 1×10⁻⁴ index change at 633 nm in the exposed region. However, glass material A exhibited some coloration in the unexposed region under these heat treatment conditions, while the unexposed region of glass material B had no visible coloration. Thus, while the photosensitivity of the glass materials used in the present invention is strongly linked to silver content, the combination of high silver concentrations and aggressive heat treatments may cause some undesired coloration in the unexposed regions of the optical elements. The skilled artisan will select silver concentrations and processing conditions to minimize any unwanted coloration.

### Example 5

Glass material D was formed into samples 1 mm in thickness. Samples were irradiated through a chrome absorption mask having a 10 μm grating pitch with the output of 248 nm radiation (70 mJ/cm²/pulse, 50 Hz). After irradiation, the samples were covered with a high purity fused silica block, then heat treated in a furnace at 550° C. for 2 hours. Microscopy indicated that the depth of the gratings was about 100 μm. The diffraction efficiency technique described above was used to estimate the index contrast of the gratings, taking into account the limited depth of the gratings. Results for various exposure times are shown in Table 4.

| Exposure time, | n_{exposed} − n_{unexposed} |
|---|---|
| minutes | (at 633 nm, ×10⁻⁴) |
| 1 | 10.4 |
| 4 | 12.5 |
| 8 | 14.6 |
| 20 | 12.1 |

### Example 6

Glass material A was formed into samples as described above. A Ti-sapphire laser was used to generate pulsed radiation having a wavelength of 800 nm, a pulsewidth of about 60 fs, a pulse frequency of 20 kHz, and a pulse powers ranging from 500-1000 nJ/pulse. The radiation was focused through a 10×Mitutoyo NIR objective having a focal length of 20 mm, a working distance of 30.5 mm, and a numerical aperture of 0.26 to yield a focused spot size of about 3 μm. A grating was formed in the glass material by scanning the sample at a velocity of 8.33 mm/min through the beam. The scan pattern was chosen to form a grating with a 10 μm pitch. The gratings had a cross-sectional area of 4×4 mm, and an index change of about 1×10⁻³.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical element comprising
a silver halide-containing glass material having a concentration of less than 0.001 wt % cerium; and
a refractive index pattern formed in the silver halide-containing glass material, the refractive index pattern including regions of high refractive index and regions of low refractive index, the difference between the refractive indices of the high refractive index regions and the low refractive index regions being at least 4×10⁻⁵ at a wavelength of 633 nm.

2. The optical element of claim 1 wherein the glass material is a borosilicate glass.

3. The optical element of claim 1 wherein the glass material includes a weak reducing agent.

4. The optical element of claim 3 wherein the weak reducing agent is selected from the group consisting of antimony(III) species, iron(II) species, tin(II) species, and arsenic(III) species.

5. The optical element of claim 3 wherein the weak reducing agent is Sb₂O₃, and is present in a concentration of about 0.5 wt % to about 6 wt %

6. The optical element of claim 1 wherein the glass material has a melting temperature no greater than about 1650° C.

7. The optical element of claim 1, wherein the optical element is stable to temperatures up to the strain point of the glass material.

8. The optical element of claim 1 wherein the glass material comprises, in weight percent as calculated from the batch,
about 5% to about 21% B₂O₃;
about 35% to about 75% SiO₂;
about 5% to about 50% total of bivalent metal oxides selected from the group consisting of
up to 50% PbO,
up to 15% ZnO, and
up to 5% BaO;
about 1% to about 4% of a weak reducing agent selected from the group consisting of Sb₂O₃; SnO; FeO; and As₂O₃.
optionally, up to about 12% Na₂O;
about 0.1% to about 1% Ag; and
about 0.1% to about 1% Cl.

9. The optical element of claim 8 wherein the glass material comprises, in weight percent as calculated from the batch,
about 12 to about 19% B₂O₃;
about 60 to about 72% SiO₂;
about 6 to about 12% Na₂O;
about 3 to about 7% ZnO;
about 0.2 to about 0.6 wt % Ag; and
about 0.15 to about 0.4 wt % Cl.

10. The optical element of claim 1, wherein the glass material comprises between about 0.1 wt % and about 1 wt % silver.

11. The optical element of claim 1, wherein the glass material comprises between about 0.3 wt % and about 0.6 wt % silver.

12. The optical element of claim 1, wherein the maximum index difference between the exposed regions of the optical element and the unexposed regions of the optical element is at least about 1×10⁻⁴ at a wavelength of 633 nm.

13. The optical element of claim 1, wherein the refractive index pattern has a minimum dimension of least about 0.11 mm.

14. The optical element of claim 1 wherein the optical element is a diffractive optical element.

15. The optical element of claim 1 wherein the optical element is a Bragg grating.

16. A method of making an optical element, the method comprising the steps of
providing a silver halide-containing glass material;
exposing the glass material to patterned ultraviolet radiation having a peak wavelength of less than about 300 nm, thereby forming exposed regions and unexposed regions; and
subjecting the exposed glass material to a heat treatment to form the optical element,
wherein exposed regions of the glass material have a substantially different refractive index than unexposed regions of the glass material after being subjected to the heat treatment.

17. The method of claim 16, wherein the glass material has less than 0.001 wt % cerium.

18. The method of claim 16 wherein the glass material includes a weak reducing agent.

19. The method of claim 18 wherein the weak reducing agent is Sb₂O₃, and is present in a concentration of about 0.5 wt % to about 6 wt %

20. The method of claim 16 wherein the glass material has a melting temperature no greater than about 1650° C.

21. The method of claim 16 wherein the glass material comprises, in weight percent as calculated from the batch,
about 5% to about 21% B₂O₃;
about 35% to about 75% SiO₂;
about 5% to about 50% total of bivalent metal oxides selected from the group consisting of
up to 50% PbO,
up to 15% ZnO, and
up to 5% BaO;
about 1% to about 4% of a weak reducing agent selected from the group consisting of Sb₂O₃.
optionally, up to about 12% Na₂O;
about 0.1% to about 1% Ag; and
about 0.1% to about 1% Cl.

22. The method of claim 16, wherein the maximum index difference between the exposed regions of the optical element and the unexposed regions of the optical element is at least about 4×10⁻⁵ at a wavelength of 633 nm.

23. The method of claim 16 wherein the heat treatment is performed at a temperature between about 450° C. and about 700° C. for a time between about 30 seconds and about 1 hour.

24. The optical element formed by the method of claim 16.

25. The optical element of claim 31 wherein the optical element is a Bragg grating.

26. A method of making an optical element, the method comprising the steps of
providing a silver halide-containing glass material;
exposing the glass material to pulsed patterned radiation having a peak wavelength of between 600 nm and 1000 nm, thereby forming exposed regions and unexposed regions; and
subjecting the exposed glass material to a heat treatment to form the optical element,
wherein exposed regions of the glass material have a substantially different refractive index than unexposed regions of the glass material after being subjected to the heat treatment.

27. The method of claim 26 wherein the pulses of the pulsed patterned radiation have pulsewidths of less than about 150 fs.

28. The method of claim 26, wherein the glass material has less than 0.001 wt % cerium.

29. The method of claim 26 wherein the glass material has a melting temperature no greater than about 1650° C.

30. The method of claim 26 wherein the glass material comprises, in weight percent as calculated from the batch,
about 5% to about 21% B₂O₃;
about 35% to about 75% SiO₂;
about 5% to about 50% total of bivalent metal oxides selected from the group consisting of
up to 50% PbO,
up to 15% ZnO, and
up to 5% BaO;
about 1% to about 4% of a weak reducing agent selected from the group consisting of Sb₂O₃; SnO; FeO; and As₂O₃.
optionally, up to about 12% Na₂O;
about 0.1% to about 1% Ag; and
about 0.1% to about 1% Cl.

31. The method of claim 26, wherein the maximum index difference between the exposed regions of the optical element and the unexposed regions of the optical element is at least about 4×10⁵ at a wavelength of 633 nm.

32. The optical element formed by the method of claim 26.

33. The optical element of claim 32 wherein the optical element is a Bragg grating.
